(19) United States
(12) Patent Application Publication
(10) Pub. No.: US 2015/0350998 A1
(43) Pub. Date: Dec. 3, 2015

(54) RELAY DEVICE AND COMMUNICATION CONTROL METHOD

(71) Applicant: FUJITSU LIMITED, Kawasaki-shi (JP)

(72) Inventor: Junichi SUGA, Ota (JP)

(21) Appl. No.: 14/665,682

(22) Filed: Mar. 23, 2015

(30) Foreign Application Priority Data
Jun. 2, 2014 (JP) 2014-114213

(51) Int. Cl. H04W 40/14; H04W 24/08; H04B 7/155

(52) U.S. Cl. CPC H04W 40/14; H04B 7/155; H04W 24/08

(57) ABSTRACT

A relay device includes: a processor and a memory configured to store a communication control program executed by the processor; wherein: the processor, based on the program, performs operations to: relay communication between a first base station in a first wireless communication network and a terminal connected to the relay device; identify a second base station in a second wireless communication network having a different communication protocol from the first wireless communication network, the second base station being present in the vicinity of the relay device; determine whether a connection is capable of being established between the second base station and the terminal; and stop a relay of the communication so that a connection target of the terminal is switched from the relay device to the second base station if the connection is capable of being established.

### CROSS-REFERENCE TO RELATED APPLICATION

This application is based upon and claims the benefit of priority of the prior Japanese Patent Application No. 2014-114213, filed on Jun. 2, 2014, the entire contents of which are incorporated herein by reference

### FIELD

The embodiments discussed herein are related to a relay device and a communication control method.

### BACKGROUND

An access point (AP) is a base station in a wireless communication network that uses a communication protocol different from a cellular communication protocol. Cellular communication protocols include communication protocols such as 3rd generation (3G) and long-term evolution (LTE). Communication protocols different from cellular communication protocols include, for example, the Wi-Fi (trademark) communication protocol. A wireless communication network that uses Wi-Fi as a communication protocol may be referred to below as a “Wi-Fi communication network”. A wireless communication network that uses a cellular communication protocol as the communication protocol may be referred to as a “cellular communication network”.

Related techniques are disclosed in Japanese National Publication of International Patent Application No. 2013-535868 and Japanese National Publication of International Patent Application No. 2013-538490.

### SUMMARY

According to an aspect of the embodiments, a relay device includes: a processor and a memory configured to store a communication control program executed by the processor; wherein: the processor, based on the program, performs operations to: relay communication between a first base station in a first wireless communication network and a terminal connected to the relay device; identify a second base station in a second wireless communication network having a different communication protocol from the first wireless communication network, the second base station being present in the vicinity of the relay device; determine whether a connection is capable of being established between the second base station and the terminal; and stop a relay of the communication so that a connection target of the terminal is switched from the relay device to the second base station if the connection is capable of being established.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a wireless communication system;

FIGS. 2A and 2B illustrate an example of an operation of a relay device;

FIG. 3 illustrates an example of a relay device;

FIG. 4 illustrates an example of monitor processing;

FIG. 5 illustrates an example of setting information;

FIG. 6 illustrates an example of identification information;

FIG. 7 illustrates an example of a mode transition;

FIG. 8 illustrates an example of communication control processing;

FIG. 9 illustrates an example of peripheral base station specification processing;

FIG. 10 illustrates an example of connection determination processing;

FIG. 11 illustrates an example of setting information notification processing;

FIG. 12 illustrates an example of communication control processing; and

FIG. 13 illustrates an example of a hardware configuration of a relay device.

### DESCRIPTION OF EMBODIMENT

An AP is installed in order to deal with an increase in traffic in a communication network that uses a cellular communication protocol. A communication carrier offloads traffic in the cellular communication network to a Wi-Fi communication network by installing an AP in the Wi-Fi communication network and switching the connection targets of terminals from the cellular communication network to the Wi-Fi communication network.

A portable relay device equipped with a relay function for relaying communication between a base station and a terminal in the cellular communication network is provided. Examples of the relay device include a mobile router or a terminal equipped with a tethering function. A user carrying the relay device may stop the relay function when an AP in the Wi-Fi communication network is present in the vicinity. When the relay function in the relay device is stopped by the user, the terminal connected to the relay device attempts to connect to the AP in the Wi-Fi communication network that is present in the vicinity.

Because the user is not typically aware of the presence of the AP, the user may not realize the presence of the AP even if an AP that the terminal can connect to is in the vicinity, and so the user may not stop the relay function of the relay device. In this case, the terminal may not autonomously connect to the AP in the vicinity because a connection between the terminal and the relay device is continuing. If the terminal is not connected to an AP in the vicinity, the cellular communication network traffic may not be sufficiently offloaded to the Wi-Fi communication network.

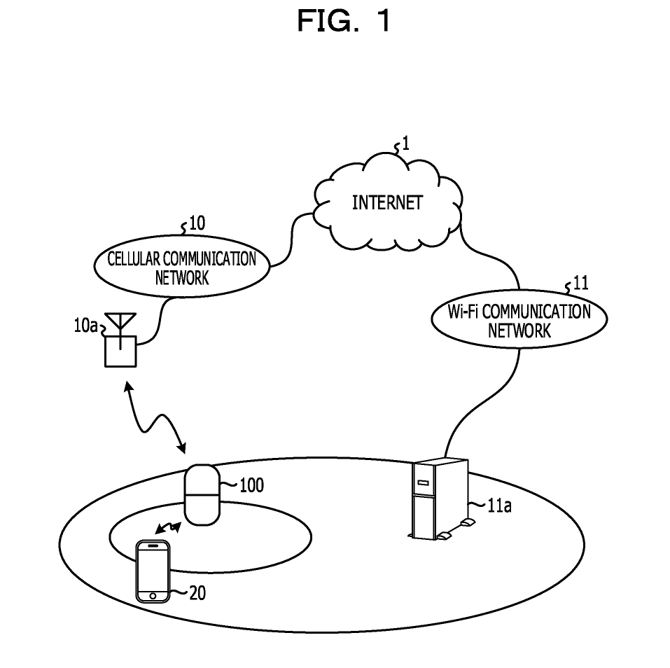

FIG. 1 illustrates an example of a wireless communication system. The wireless communication system illustrated in FIG. 1 includes the Internet 1, a cellular communication network 10, a Wi-Fi communication network 11, a terminal 20, and a relay device 100. The Internet 1 is a wide communication network having a large capacity. The cellular communication network 10 may be a wireless communication network that uses a cellular communication protocol such as 3G or LTE as the communication protocol. The Wi-Fi communication network 11 may be a wireless communication network that uses Wi-Fi (trademark) as the communication protocol. The cellular communication network 10 and the Wi-Fi communication network 11 may respectively correspond to a first wireless communication network and a second wireless communication network.

The cellular communication network 10 and the Wi-Fi communication network 11 may be managed by the same communication carrier or by different communication carriers. A communication area formed by an access point (AP) 11a in the Wi-Fi communication network 11 may be smaller than a communication area formed by a base station 10a in the cellular communication network 10. A communication area may be an area in which radio waves transmitted by a base station reach at least a certain power value. The AP 11a in the Wi-Fi communication network 11 may correspond to an example of a base station in the second wireless communication network having a communication protocol different from the first wireless communication network.

The terminal 20 may be a wireless communication terminal such as a notebook personal computer (PC) or a smartphone. The terminal 20 is connected to the base station 10a in the cellular communication network 10 or the AP 11a in the Wi-Fi communication network 11 and accesses the Internet 1 through the cellular communication network 10 or the Wi-Fi communication network 11. In FIG. 1, the terminal 20 uses communication between the terminal 20 and the base station 10a in the cellular communication network 10 relayed by the relay device 100 to connect to the base station 10 in the cellular communication network 10, and accesses the Internet 1 through the cellular communication network 10.

The relay device 100 is equipped with a relay function for relaying communication between the base station 10a in the cellular communication network 10 and the terminal 20 connected to the relay device 100, and may be a portable relay device. The relay device 100 may be, for example, a mobile router or a terminal equipped with a tethering function.

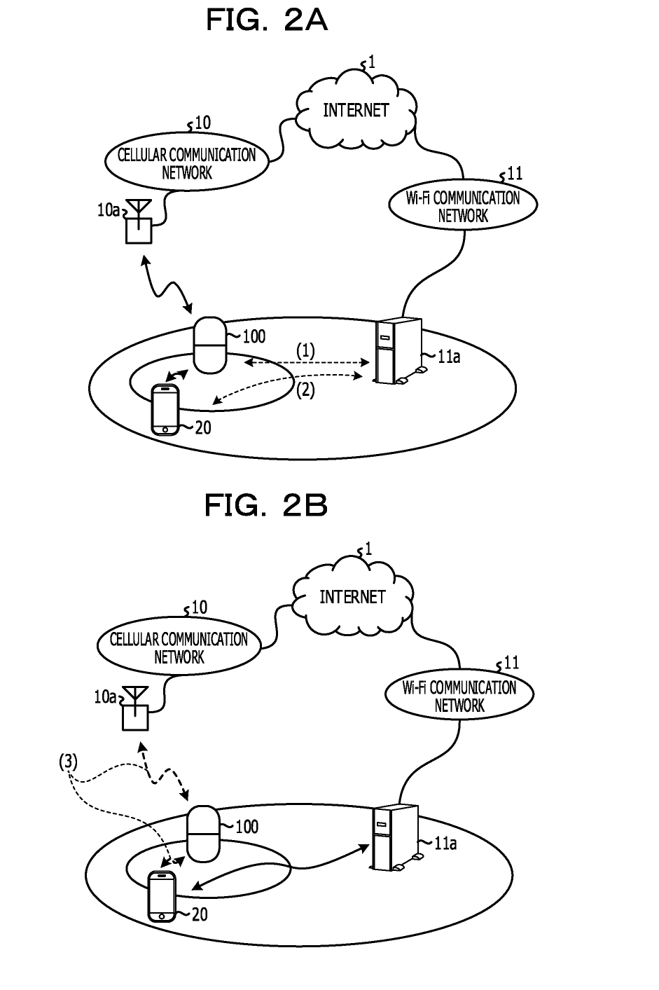

FIGS. 2A and 2B illustrate an example of an operation performed by a relay device. For example, the relay device 100 relays communication between the base station 10a in the cellular communication network 10 and the terminal 20 connected to the relay device 100 as illustrated in FIG. 2A.

The relay device 100 specifies a peripheral base station which is a base station in the Wi-Fi communication network 11 and present in the vicinity of the relay device 100. For example, the relay device 100 specifies the AP 11a in the Wi-Fi communication network 11 as the peripheral base station (See (1) in FIG. 2A).

The relay device 100 determines whether a connection is established between the peripheral base station and the terminal 20. For example, the relay device 100 determines whether a connection is established between the AP 11a in the Wi-Fi communication network 11 specified as the peripheral base station and the terminal 20 (see (2) in FIG. 2A). For example, the connection between the AP 11a in the Wi-Fi communication network 11 and the terminal 20 may be determined as established if the reception power of a signal transmitted from the AP 11a in the Wi-Fi communication network 11 is larger than a threshold X and if the reception power of a signal transmitted from the terminal 20 is larger than a threshold Y.

When it is determined that the connection between the peripheral base station and the terminal 20 is established, the relay device 100 stops relaying the communication between the base station 10a in the cellular communication network 10 and the terminal 20 so that the connection target of the terminal 20 is switched from the relay device 100 to the peripheral base station. For example, a connection between the AP 11a in the Wi-Fi communication network 11 that is the peripheral base station and the terminal 20 may be established. In this case, the relay device 100 stops relaying the communication between the base station 10a in the cellular communication network 10 and the terminal 20 so that the connection target of the terminal 20 is switched from the relay device 100 to the AP 11a in the Wi-Fi communication network 11 (see (3) in FIG. 2B).

When the relay device determines that a connection is established between the terminal 20 and the AP 11a in the Wi-Fi communication network 11 which is present in the vicinity of the relay device 100, the relay device 100 stops relaying the communication between the base station 10a in the cellular communication network 10 and the terminal 20. As a result, the terminal 20 connected to the relay device 100 may attempt to connect to the AP 11a in the Wi-Fi communication network 11 that is present in the vicinity without an operation from the user. The terminal 20 may be prompted by the relay device 100 to establish an autonomous connection with the AP 11a present in the vicinity.

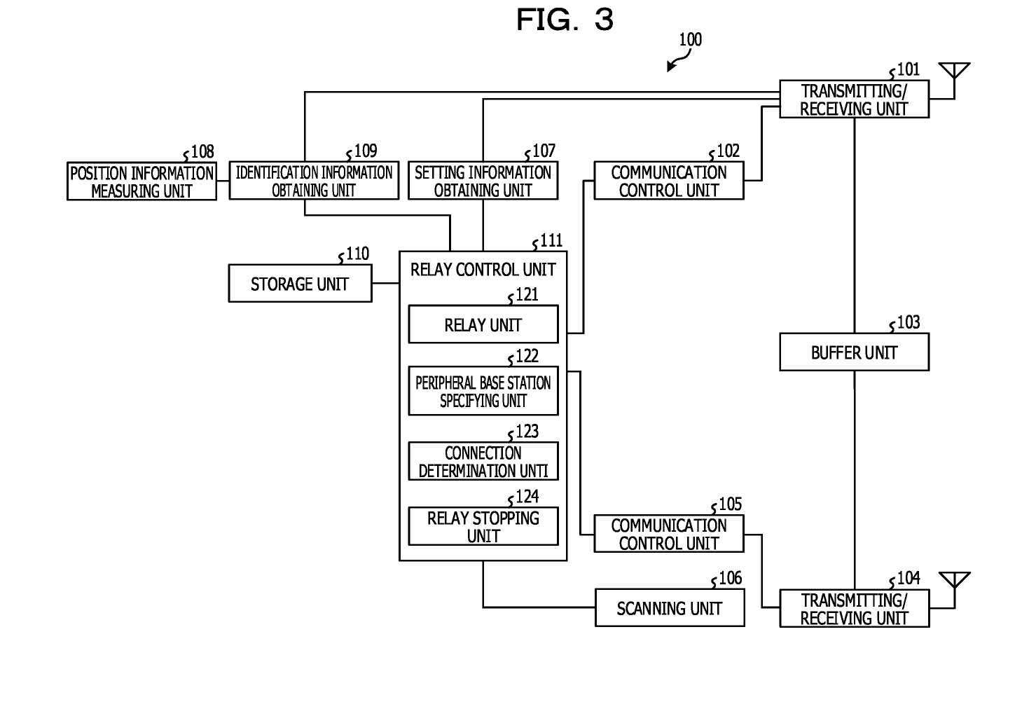

FIG. 3 illustrates an example of a relay device. As illustrated in FIG. 3, the relay device 100 has a transmitting/receiving unit 101, a communication control unit 102, a buffer unit 103, a transmitting/receiving unit 104, a communication control unit 105, a scanning unit 106, a setting information obtaining unit 107, a position information measuring unit 108, and an identification information obtaining unit 109. The relay device 100 has a storage unit 110 and a relay control unit 111.

The transmitting/receiving unit 101 receives data from the base station 10a in the cellular communication network 10 and outputs the received data to the buffer unit 103. The transmitting/receiving unit 101 transmits data input from the buffer unit 103 to the base station 10a in the cellular communication network 10.

The communication control unit 102 controls the connection between the transmitting/receiving unit 101 and the base station 10a in the cellular communication network 10 in accordance with instructions from a relay unit 121 in the relay control unit 111. For example, the communication control unit 102 connects the connection between the transmitting/receiving unit 101 and the base station 10a in the cellular communication network 10 based on an instruction from the relay unit 121 to relay communication between the base station 10a in the cellular communication network 10 and the terminal 20. The communication control unit 102 disconnects the connection between the transmitting/receiving unit 101 and the base station 10a in the cellular communication network 10 based on an instruction from the relay unit 121 to stop relaying communication between the base station 10a in the cellular communication network 10 and the terminal 20.

The buffer unit 103 temporarily holds data input from the transmitting/receiving unit 101 and outputs the data to the transmitting/receiving unit 104. The buffer unit 103 temporarily holds data input from the transmitting/receiving unit 104 and outputs the data to the transmitting/receiving unit 101.

The transmitting/receiving unit 104 receives data from the terminal 20 and outputs the received data to the buffer unit 103. The transmitting/receiving unit 104 transmits data input from the buffer unit 103 to the terminal 20.

The communication control unit 105 controls the connection between the transmitting/receiving unit 104 and the terminal 20 in accordance with instructions from the relay unit 121 in the relay control unit 111. For example, the communication control unit 105 connects the connection between the transmitting/receiving unit 104 and the terminal 20 based on an instruction from the relay unit 121 to relay communication between the base station 10a in the cellular communication network 10 and the terminal 20 connected to the relay device 100. The communication control unit 105 disconnects the connection between the transmitting/receiving unit 104 and the terminal 20 based on an instruction from the relay unit 121 to stop relaying communication between the base station 10a in the cellular communication network 10 and the terminal 20.

The scanning unit 106 captures a beacon signal transmitted from the AP 11a in the Wi-Fi communication network 11 and outputs the captured beacon signal to the relay control unit 111. The scanning unit 106 measures the reception power of a signal transmitted from the AP 11a in the Wi-Fi communication network 11 and outputs the measured value of the reception power to the relay control unit 111. The scanning unit 106 measures the reception power of a signal transmitted from the terminal 20 and outputs the measured value of the reception power to the relay control unit 111. When the connection target of the terminal 20 is switched from the relay device 100 to the peripheral base station, the scanning unit 106 captures data transmitted between the peripheral base station and the terminal 20 and outputs the captured data to the relay control unit 111.

The setting information obtaining unit 107 obtains setting information for setting a connection between the peripheral base station and the terminal 20. For example, the setting information obtaining unit 107 obtains, through the transmitting/receiving unit 101, the setting information from a server of the cellular communication network 10 that holds the setting information.

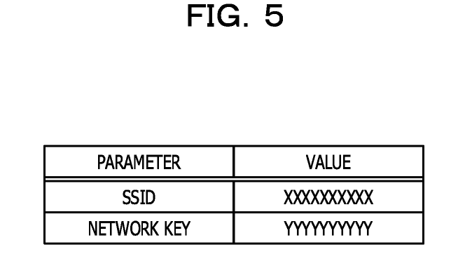

FIG. 5 illustrates an example of setting information. The setting information illustrated in FIG. 5 may be obtained by the setting information obtaining unit 107 illustrated in FIG. 3. As illustrated in FIG. 5, the setting information includes a service set identifier (SSID) and a network key. The SSID is an identifier for identifying the Wi-Fi communication network. The network key is a key used when encrypting data exchanged with the Wi-Fi communication network.

The position information measuring unit 108 measures the position information of the relay device 100. For example, the position information measuring unit 108 uses a global positioning system (GPS) function to measure the position information of the relay device 100. The position information measuring unit 108 outputs the measured position information of the relay device 100 to the identification information obtaining unit 109.

The identification information obtaining unit 109 obtains the identification information of the AP 11a in the Wi-Fi communication network 11 present within a certain range based on the position indicated in the position information of the relay device 100. For example, the position information of the relay device 100 and the identification information of the AP 11a in the Wi-Fi communication network 11 present within the certain range based on the position indicated in the position information of the relay device, are saved in association with each other in a server of the cellular communication network 10. The identification information obtaining unit 109 obtains the identification information of the AP 11a in the Wi-Fi communication network 11 associated with the position information measured by the position information measuring unit 108 from a server of the cellular communication network 10.

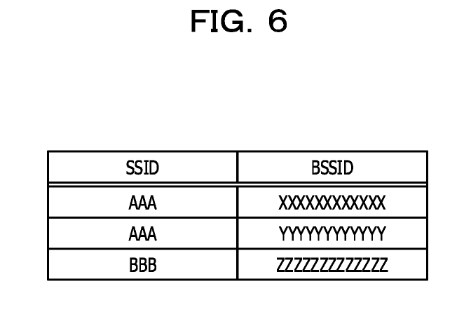

FIG. 6 illustrates an example of identification information. The setting information illustrated in FIG. 5 may be obtained by the identification information obtaining unit 109 illustrated in FIG. 3. The identification information obtaining unit 109 obtains a combination of SSIDs and BSSIDs as the identification information of the AP 11a in the Wi-Fi communication network 11 associated with the position information measured by the position information measuring unit 108 as illustrated in FIG. 6. The SSID is an identifier for identifying the Wi-Fi communication network. The BSSID is an identifier for identifying an AP in a Wi-Fi communication network and may correspond to a MAC address of an AP in a Wi-Fi communication network.

The identification information obtaining unit 109 obtains the combination of SSIDs and BSSIDs as the identification information of the AP 11a in the Wi-Fi communication network 11 as illustrated in FIG. 6. For example, the identification information obtaining unit 109 may obtain only the SSIDs or only the BSSIDs as the identification information of the AP 11a in the Wi-Fi communication network 11.

The storage unit 110 stores various types of data and information used in the communication control processing performed by the relay control unit 111. The setting information obtained by the setting information obtaining unit 107 and the identification information obtained by the identification information obtaining unit 109 are stored for example in the storage unit 110.

The relay control unit 111 includes the relay unit 121, a peripheral base station specifying unit 122, a connection determination unit 123, and a relay stopping unit 124.

The relay unit 121 relays communication between the base station 10a in the cellular communication network 10 and the terminal 20 connected to the relay device 100. For example, the relay unit 121 instructs the communication control unit 102 and the communication control unit 105 to relay the communication between the base station 10a in the cellular communication network 10 and the terminal 20.

The relay unit 121 instructs the communication control unit 102 and the communication control unit 105 to stop the communication between the base station 10a in the cellular communication network 10 and the terminal 20 connected to the relay device 100 when a request to stop relaying the communication is received from the relay stopping unit 124.

The peripheral base station specifying unit 122 specifies a peripheral base station which is a base station in the Wi-Fi communication network 11 and present in the vicinity of the relay device 100. For example, the peripheral base station specifying unit 122 receives, from the scanning unit 106, an input of a beacon signal transmitted from the AP 11a in the Wi-Fi communication network 11. The peripheral base station specifying unit 122 determines whether the identification information of the AP 11a in the Wi-Fi communication network 11 included in the beacon signal matches the identification information obtained by the identification information obtaining unit 109. If the identification information of the AP 11a in the Wi-Fi communication network 11 included in the beacon signal matches the identification information obtained by the identification information obtaining unit 109, the peripheral base station specifying unit 122 specifies the AP 11a in the Wi-Fi communication network 11 as the peripheral base station.

The connection determination unit 123 determines whether a connection is established between the peripheral base station and the terminal 20. For example, the connection determination unit 123 receives, from the scanning unit 106, the reception power value (referred to as an “AP reception power value” below) of a signal transmitted from the AP 11a in the Wi-Fi communication network 11 as the peripheral base station. The connection determination unit 123 receives, from the scanning unit 106, the reception power value (referred to as a “terminal reception power value” below) of a signal transmitted from the terminal 20. The connection determination unit 123 may determine that a connection between the AP 11a as the peripheral base station and the terminal 20 is established if the AP reception power value is greater than the threshold X and the terminal reception power value is greater than the threshold Y.

When it is determined that the connection between the peripheral base station and the terminal 20 is established by the connection determination unit 123, the relay stopping unit 124 stops relaying the communication by the relay unit 121 so that the connection target of the terminal 20 is switched from the relay device 100 to the peripheral base station. For example, the relay stopping unit 124 issues a request to the relay unit 121 to stop relaying the communication when it has been determined by the connection determination unit 123 that communication is established between the peripheral base station and the terminal 20.

The relay stopping unit 124 confirms whether or not the terminal 20 has the setting information when it has been determined by the connection determination unit 123 that the connection between the peripheral base station and the terminal 20 is established. If the terminal 20 does not have the setting information, the relay stopping unit 124 notifies the terminal 20 of the setting information stored in the storage unit 110, and after the notification of the setting information, the relay stopping unit 124 stops relaying the communication by the relay unit 121.

The relay stopping unit 124 monitors the communication quality between the peripheral base station and the terminal 20 after stopping the relay of communication by the relay unit 121. The relay stopping unit 124 restarts the communication by the relay unit 121 if the communication quality between the peripheral base station and the terminal 20 does not satisfy a certain communication quality.

For example, while the relay stopping unit 124 monitors the communication quality between the peripheral base station and the terminal 20, the relay stopping unit 124 receives data transmitted between the terminal 20 and the AP 11a in the Wi-Fi communication network 11 as the peripheral base station through the scanning unit 106. The relay stopping unit 124 monitors a certain value added to the data as the communication quality.

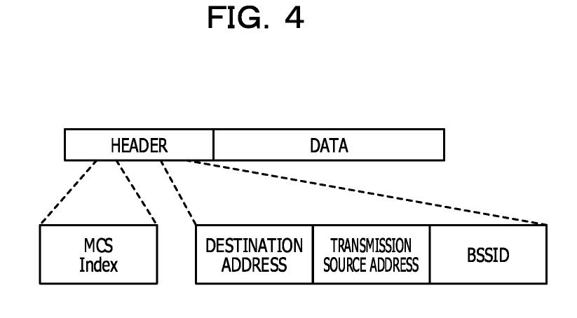

FIG. 4 illustrates an example of monitoring processing. The monitoring processing illustrated in FIG. 4 may be performed by the relay stopping unit 124 illustrated in FIG. 3. FIG. 4 illustrates an example of data transmitted between the terminal 20 and the AP 11a in the Wi-Fi communication network 11 as the peripheral base station. A header is added to the head of the data transmitted between the terminal 20 and the AP 11a in the Wi-Fi communication network 11 as the peripheral base station as illustrated in FIG. 4. The header includes a destination address, a transmission source address, a basic service set identifier (BSSID), a modulation and coding scheme (MCS) index, and so on. The destination address is an address that indicates the destination of the data. The transmission source address is an address that indicates the transmission source of the data. The BSSID is an identifier for identifying a Wi-Fi communication network and may correspond to the MAC address of an AP in a Wi-Fi communication network. The MCS index is a value for identifying the modulation encoding protocol of the data. The value of the MCS index increases in correspondence to an increase in the transfer rate of data transferred using the modulation encoding protocol. As a result, the relay stopping unit 124 extracts the MCS index added to the data transmitted between the terminal 20 and the AP 11a in the Wi-Fi communication network 11 as the peripheral base station, and determines whether the value of the extracted MCS index is greater than a threshold I. If the value of the MCS index is greater than the threshold I, the relay stopping unit 124 determines that the communication quality between the peripheral base station and the terminal 20 satisfies the certain communication quality, and stops the relay of communication by the relay unit 121 in a continuous manner. Conversely, if the value of the MCS index is equal to or less than the threshold I, the relay stopping unit 124 determines that the communication quality between the peripheral base station and the terminal 20 does not satisfy the certain communication quality, and restarts the relay of communication by the relay unit 121.

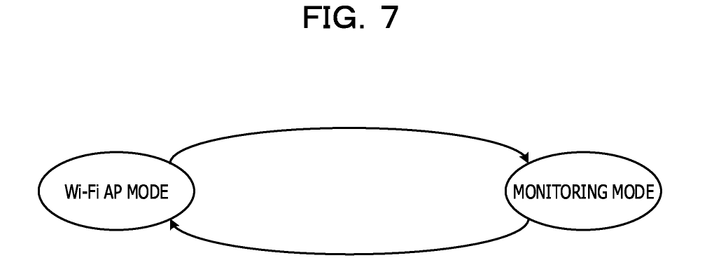

FIG. 7 illustrates an example of a mode transition. The mode transition illustrated in FIG. 7 may be a mode transition of the relay device 100 illustrated in FIG. 3. As illustrated in FIG. 7, the mode of the relay device 100 is switched between a Wi-Fi AP mode and a monitoring mode. The relay device 100 relays communication between the base station 10a in the cellular communication network 10 and the terminal 20 connected to the relay device 10 in the Wi-Fi AP mode. When it is determined that a connection is established between the terminal 20 and the AP 11a in the Wi-Fi communication network 11 which is present in the vicinity of the relay device 100, the relay device 100 stops relaying the communication between the base station 10a in the cellular communication network 10 and the terminal 20 in the Wi-Fi AP mode. As a result, the mode of the relay device 100 is switched from the Wi-Fi AP mode to the monitoring mode. The relay device 100 monitors the communication quality between the peripheral base station and the terminal 20 in the monitoring mode. The relay device 100 restarts the communication by the relay unit 121 if the communication quality between the peripheral base station and the terminal 20 does not satisfy the certain communication quality. As a result, the mode of the relay device 100 is switched from the monitoring mode to the Wi-Fi AP mode.

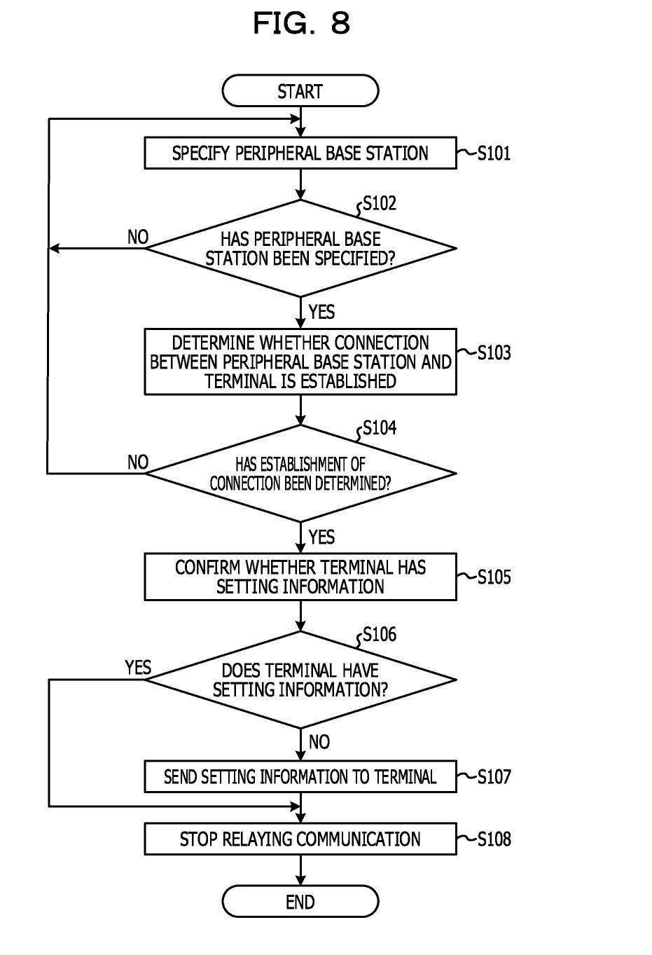

FIG. 8 illustrates an example of communication control processing. The processing illustrated in FIG. 8 may be the communication control processing performed by the relay device 100 illustrated in FIG. 3 in the Wi-Fi AP mode.

As illustrated in FIG. 8, the peripheral base station specifying unit 122 of the relay device 100 specifies a peripheral base station (operation S101). If a peripheral base station is not specified by the peripheral base station specifying unit 122 (operation S102: No), the processing returns to operation S101.

If a peripheral base station is specified by the peripheral base station specifying unit 122 (operation S102: Yes), the connection determination unit 123 determines whether a connection is established between the peripheral base station and the terminal 20 (operation S103). If the connection determination unit 123 determines that no connection is established between the peripheral base station and the terminal 20 (operation S104: No), the processing returns to operation S101.

If the connection determination unit 123 determines that the connection between the peripheral base station and the terminal 20 is established (operation S104: Yes), the relay stopping unit 124 confirms whether or not the terminal 20 has the setting information (operation S105). If the terminal 20 does not have the setting information (operation S106: No), the relay stopping unit 124 notifies the terminal 20 of the setting information stored in the storage unit 110 (operation S107). The processing then moves to operation S108.

If the terminal 20 has the setting information (operation S106: Yes), the relay stopping unit 124 stops relaying the communication by the relay unit 121 in order to switch the connection target of the terminal 20 from the relay device 100 to the peripheral base station (operation S108).

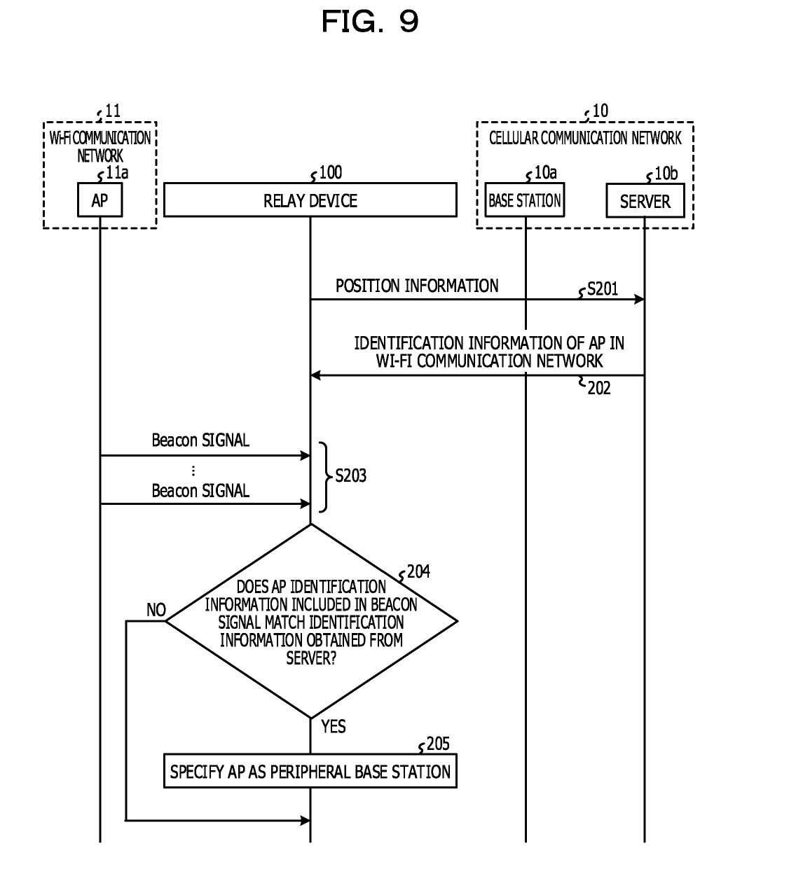

FIG. 9 illustrates an example of peripheral base station specification processing. The processing illustrated in FIG. 9 may correspond to the operation S101 in FIG. 8. A server 10b illustrated in FIG. 9 may be a server of the cellular communication network 10. The server 10b holds, in association with each other, the position information of the relay device 100 and the identification information of the AP 11a in the Wi-Fi communication network 11 present within the certain range based on the position indicated in the position information of the relay device 100.

As illustrated in FIG. 9, the identification information obtaining unit 109 of the relay device 100 notifies the server 10b of the position information of the relay device 100 measured by the position information measuring unit 108 (operation S201). The server 10b in the cellular communication network 10 that receives the position information of the relay device 100 sends back identification information of the AP 11a in the Wi-Fi communication network 11 associated with the position information of the relay device 100 to the relay device 100.

The identification information obtaining unit 109 obtains the identification information of the AP 11a in the Wi-Fi communication network 11 sent back by the server 10b in the cellular communication network 10 (operation S202). The identification information of the AP 11a in the Wi-Fi communication network 11 obtained by the identification information obtaining unit 109 is stored in the storage unit 110.

The scanning unit 106 of the relay device 100 captures a beacon signal transmitted from the AP 11a in the Wi-Fi communication network 11 (operation S203).

The peripheral base station specifying unit 122 of the relay device 100 receives the input of the beacon signal from the scanning unit 106. The peripheral base station specifying unit 122 determines whether the identification information of the AP 11a in the Wi-Fi communication network 11 included in the beacon signal matches the identification information obtained by the identification information obtaining unit 109 (operation S204). If the identification information of the AP 11a in the Wi-Fi communication network 11 included in the beacon signal does not match the identification information obtained by the identification information obtaining unit 109 (operation S204: No), the processing is finished.

The peripheral base station specifying unit 122 performs the following processing if it is determined that the identification information of the AP 11a in the Wi-Fi communication network 11 included in the beacon signal matches the identification information obtained by the identification information obtaining unit 109 (operation S204: Yes). For example, the peripheral base station specifying unit 122 specifies the AP 11a in the Wi-Fi communication network 11 as the peripheral base station (operation S205).

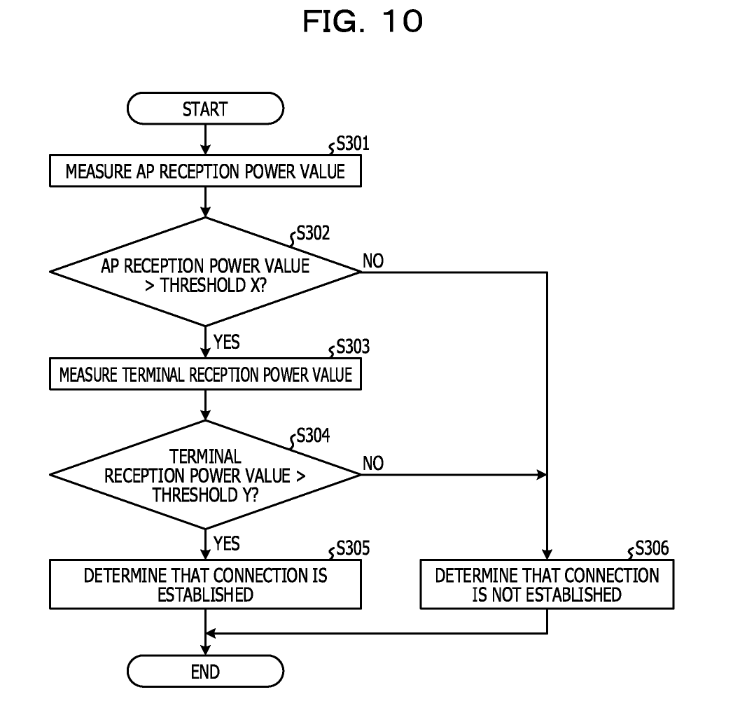

FIG. 10 illustrates an example of connection determination processing. The processing illustrated in FIG. 10 may correspond to the operation S103 in FIG. 8.

As illustrated in FIG. 10, the scanning unit 106 of the relay device 100 measures the AP reception power value (operation S301). The scanning unit 106 outputs the measured AP reception power value to the connection determination unit 123.

The connection determination unit 123 receives the AP reception power value from the scanning unit 106 and determines whether the AP reception power value is greater than the threshold X (operation S302). When the connection determination unit 123 determines that the AP reception power value is greater than the threshold X (operation S302: Yes), the scanning unit 106 measures the terminal reception power value (operation S303). The scanning unit 106 outputs the measured terminal reception power value to the connection determination unit 123.

The connection determination unit 123 receives the terminal reception power value from the scanning unit 106 and determines whether the terminal reception power value is greater than the threshold Y (operation S304). If the terminal reception power value is greater than the threshold Y (operation S304: Yes), the connection determination unit 123 determines that a connection between the AP 11a as the peripheral base station and the terminal 20 is established (operation S305).

If the AP reception power value is equal to or less than the threshold X (operation S302: No), or if the terminal reception power value is equal to or less than the threshold Y (operation S304: No), the connection determination unit 123 determines that no connection is established between the AP 11a as the peripheral base station and the terminal 20 (operation S306).

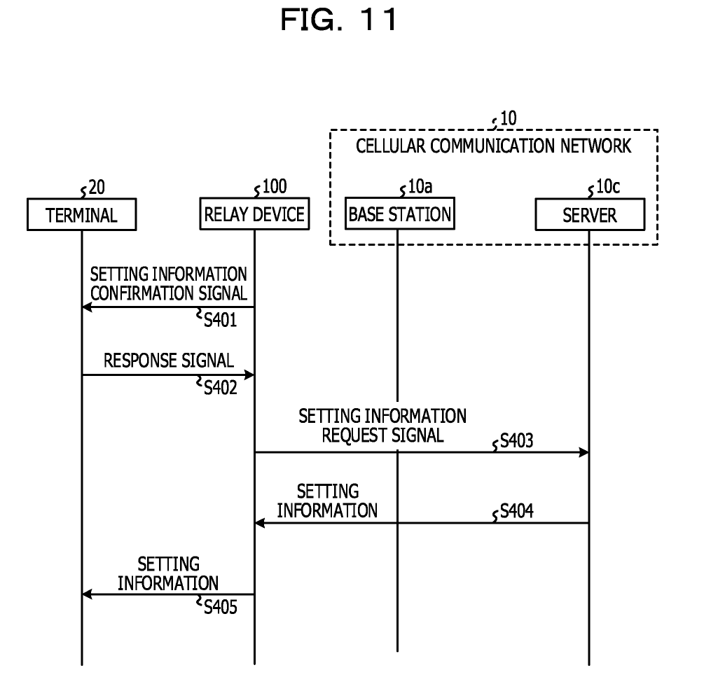

FIG. 11 illustrates an example of setting information notification processing. The processing illustrated in FIG. 11 may correspond to the operations S105 to S107 in FIG. 8. A server 10c in FIG. 11 may be a server of the cellular communication network 10 and may have the setting information for setting the connection between the peripheral base station and the terminal 20. The terminal 20 may not have the setting information.

As illustrated in FIG. 11, the relay stopping unit 124 of the relay device 100 transmits a setting information confirmation signal for confirming whether or not the terminal 20 has the setting information, to the terminal 20 (operation S401). The terminal 20 that receives the setting information confirmation signal sends back to the relay device 100 a response signal that indicates that the terminal 20 does not have the setting information (operation S402).

The setting information obtaining unit 107 of the relay device 100 sends a setting information request signal for requesting the setting information to the server 10c in the cellular communication network 10 (operation S403). The server 10c in the cellular communication network 10 that receives the setting information request signal notifies the relay device 100 of the setting information (operation S404). The relay device 100 that receives the setting information stores the setting information in the storage unit 110.

Because the terminal 20 does not have the setting information, the relay stopping unit 124 of the relay device 100 notifies the terminal 20 of the setting information stored in the storage unit 110 (operation S405).

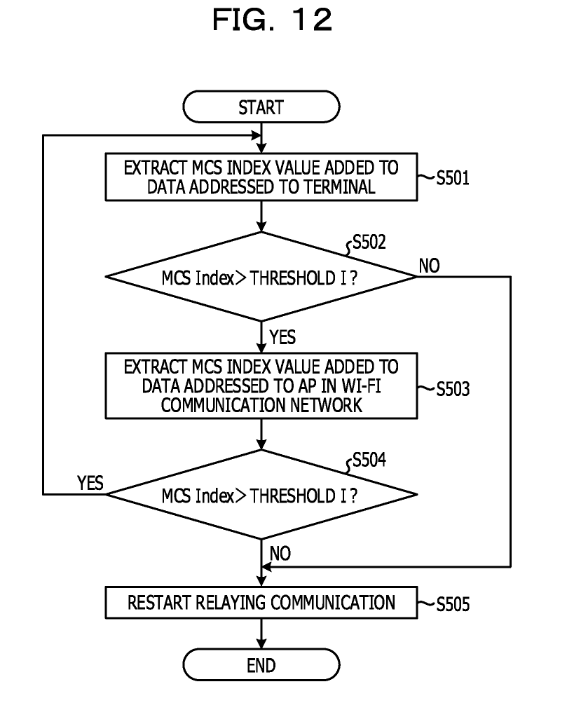

FIG. 12 illustrates an example of communication control processing. FIG. 12 illustrates communication control processing performed in the monitoring mode by the relay device 100 illustrated in FIG. 3.

As illustrated in FIG. 12, the relay stopping unit 124 of the relay device 100 extracts the value of the MCS index added to the data (referred to as “data addressed to the terminal” below) transmitted from the AP 11a in the Wi-Fi communication network 11 as the peripheral base station to the terminal 20 (operation S501). The relay stopping unit 124 determines whether the value of the MCS index extracted from the data addressed to the terminal is greater than the threshold I (operation S502).

If the relay stopping unit 124 determines that the value of the MCS index extracted from the data addressed to the terminal is greater than the threshold I (operation S502: Yes), the following processing is performed. For example, the relay stopping unit 124 extracts the value of the MCS index added to the data (referred to as “data addressed to the AP” below) transmitted from the terminal 20 to the AP 11a in the Wi-Fi communication network 11 as the peripheral base station (operation S503). The relay stopping unit 124 determines whether the value of the MCS index extracted from the data addressed to the AP is greater than the threshold I (operation S504). If the value of the MCS index extracted from the data addressed to the AP is greater than the threshold I (operation S504: Yes), the relay stopping unit 124 determines that the communication quality between the peripheral base station and the terminal 20 satisfies the certain communication quality, and the processing returns to operation S501. If the communication quality between the peripheral base station and the terminal 20 satisfies the certain communication quality in the monitoring mode, the relay stopping unit 124 stops relaying the communication by the relay unit 121 in a continuous manner.

If the value of the MCS index extracted from the data addressed to terminal is equal to or less than the threshold I (operation S502: No), or if the value of the MCS index extracted from the data addressed to AP is equal to or less than the threshold I (operation S504: No), the relay stopping unit 124 performs the following processing. For example, the relay stopping unit 124 determines that the communication quality between the peripheral base station and the terminal 20 does not satisfy the certain communication quality, and restarts relaying communication by the relay unit 121 (operation S505).

When it is determined that a connection is established between the terminal 20 and the AP 11a in the Wi-Fi communication network 11 which is present in the vicinity of the relay device 100, the relay device 100 stops relaying the communication between the base station 10a in the cellular communication network 10 and the terminal 20. As a result, the terminal 20 connected to the relay device 100 may attempt to connect to the AP 11a in the Wi-Fi communication network 11 that is present in the vicinity without an operation from the user. The terminal 20 may be prompted by the relay device 100 to establish an autonomous connection with the AP 11a present in the vicinity.

The relay device 100 monitors the communication quality between the terminal 20 and the AP 11a in the Wi-Fi communication network 11 as the peripheral base station after relaying of the communication has been stopped, and restarts relaying the communication if the communication quality does not satisfy the certain communication quality. If the communication quality between the terminal 20 and the AP 11a present in the vicinity deteriorates, the communication between the terminal 20 and the base station 10a in the cellular communication network 10 may be automatically restarted without an operation from the user in the relay device 100.

When it is determined that a connection is established between the terminal 20 and the AP 11a in the Wi-Fi communication network 11 present in the vicinity, the relay device 100 notifies the terminal 20 that does not have the setting information the setting information and then stops relaying the communication. The terminal 20 may be prompted by the relay device 100 to establish an autonomous connection with the AP 11a present in the vicinity and the connection between the terminal 20 and the AP 11a present in the vicinity may be set in a secure manner.

The relay device 100 obtains the identification information of the AP 11a in the Wi-Fi communication network 11 present within a certain range based on the position indicated in the position information of the relay device 100. If the identification information of the AP 11a in the Wi-Fi communication network 11 included in the signal transmitted from the AP 11a in the Wi-Fi communication network 11 matches the previously obtained identification information, the relay device 100 specifies the AP 11a in the Wi-Fi communication network 11 as the peripheral base station. The AP 11a present in the vicinity may be automatically specified by the relay device 100.

One terminal 20 may be connected to the relay device 100 or a plurality of terminals 20 may be connected to the relay device 100. For example, the relay unit 121 in the relay device 100 relays communication between the base station 10a in the cellular communication network 10 and each of the plurality of terminals 20. The connection determination unit 123 determines whether connections are established between the peripheral base station and each of the terminals 20.

The relay stopping unit 124 stops relaying the communication by the relay unit 121 when it has been determined by the connection determination unit 123 that communication is established between the peripheral base station and all of the terminals 20.

The relay stopping unit 124 monitors the communication quality between the peripheral base station and each of the plurality of terminals 20 after stopping the relay of the communication by the relay unit 121. The relay stopping unit 124 restarts the communication by the relay unit 121 if the communication quality between the peripheral base station and any one of the terminals 20 among the plurality of terminals 20 does not satisfy a certain communication quality.

When a connection is established between the terminal 20 and the AP 11a which is present in the vicinity of the relay device 100, the relay device 100 stops relaying the communication between the base station 10a in the cellular communication network 10 and the terminal 20 in the Wi-Fi AP mode. For example, even if a connection is established between the AP 11a in the Wi-Fi communication network 11 and the terminal 20, the relay of the communication may be continued if the communication quality between the relay device 100 and the base station 10a in the cellular communication network 10 satisfies the certain communication quality. In this case, the relay device 100 may be provided with a monitoring unit for monitoring the communication quality between the relay device 100 and the base station 10a in the cellular communication network 10.

For example, even if the connection between the terminal 20 and the peripheral base station is determined by the connection determination unit 123 as being established, the relay stopping unit 124 performs the following processing if the communication quality between the relay device 100 and the base station 10a in the cellular communication network 10 satisfies the certain communication quality. For example, the relay stopping unit 124 continues the relay of the communication by the relay unit 121. For example, the relay stopping unit 124 continues the relay of the communication by the relay unit 121 if the value of the MCS index added to the data transmitted between the base station 10a in the cellular communication network 10 and the relay device 100 is equal to or greater than a certain threshold. As a result, switching the mode from the Wi-Fi AP mode to the monitoring mode is stopped. Frequent switching of the modes may be reduces and outages in communication may be reduced.

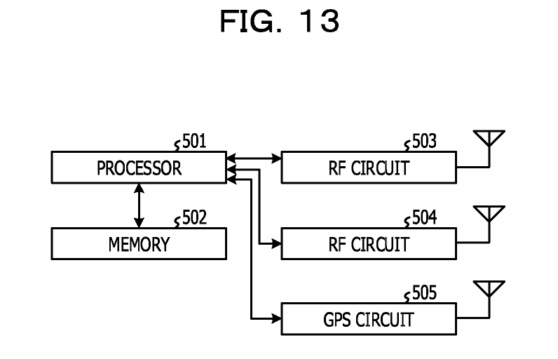

FIG. 13 illustrates an example of a hardware configuration of a relay device.

As illustrated in FIG. 13, the relay device 100 has a processor 501, a memory 502, a radio frequency (RF) circuit 503, a RF circuit 504, and a GPS circuit 505 as hardware constituent elements. The storage unit 110 illustrated in FIG. 3 may include the memory 502, and the memory 502 may be a random access memory (RAM), a read-only memory (ROM), or a flash memory. The transmitting/receiving unit 101 and the communication control unit 102 illustrated in FIG. 3 may include, for example, the RF circuit 503. The transmitting/receiving unit 104, the communication control unit 105, and the scanning unit 106 illustrated in FIG. 3 may include, for example, the RF circuit 504. The position information measuring unit 108 illustrated in FIG. 3 may include, for example, the GPS circuit 505. The setting information obtaining unit 107, the identification information obtaining unit 109, and the relay control unit 111 illustrated in FIG. 3 may include, for example, the processor 501.

The above processing may be realized by a computer executing a previously prepared program. Programs corresponding to the processing executed by the relay unit 121, the peripheral base station specifying unit 122, the connection determination unit 123, and the relay stopping unit 124 in the relay control unit 111 may be recorded in the memory 502 and the programs may function as processes read out by the processor 501.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A relay device comprising:
a processor and
a memory configured to store a communication control program executed by the processor; wherein:
the processor, based on the program, performs operations to:
relay communication between a first base station in a first wireless communication network and a terminal connected to the relay device;
identify a second base station in a second wireless communication network having a different communication protocol from the first wireless communication network, the second base station being present in the vicinity of the relay device;
determine whether a connection is capable of being established between the second base station and the terminal; and
stop a relay of the communication so that a connection target of the terminal is switched from the relay device to the second base station if the connection is be capable of being established.

2. The relay device according to claim 1, wherein
the processor monitors a communication quality between the second base station and the terminal after stopping the relay of the communication, and restarts the relay of the communication if the communication quality does not satisfy a certain communication quality.

3. The relay device according to claim 1, wherein
the processor obtains, from another device, setting information for setting the connection between the second base station and the terminal.

4. The relay device according to claim 3, wherein
the processor confirms whether the terminal has the setting information when the connection between the second base station and the terminal is capable of being established, and if the terminal does not have the setting information, notifies the terminal of the setting information.

5. The relay device according to claim 4, wherein
the processor stops the relay of the communication after notifying the setting information.

6. The relay device according to claim 1, wherein
the processor measures position information of the relay device; and
obtains first identification information of a third base station in the second wireless communication network that is present within a certain range based on the position indicated by the position information.

7. The relay device according to claim 6, wherein
the processor identifies the third base station in the second wireless communication network as the second base station if the first identification information matches second identification information included in a signal transmitted from the third base station in the second wireless communication network.

8. The relay device according to claim 1, wherein
the processor relays communication between the first base station in the first wireless communication network and a plurality of terminals including the terminal;
determines whether a connection is capable of being established between the second base station and each of the plurality of terminals; and
stops the relay of the communication if the connection is capable of being established between the second base station and all of the plurality of the terminals.

9. The relay device according to claim 8, wherein
the processor monitors a communication quality between the second base station and each of the plurality of terminals after stopping the relay of the communication; and
restarts the relay of the communication if the communication quality between the second base station and at least one terminal among the plurality of terminals does not satisfy a certain communication quality.

10. The relay device according to claim 1, wherein
the processor monitors a communication quality between the relay device and the first base station; and
continues the relay of the communication if the communication quality satisfies a certain communication quality even if the connection is capable of being established.

11. A communication control method, comprising:
relaying communication between a first base station in a first wireless communication network and a terminal;
identifying a second base station in a second wireless communication network having a different communication protocol from the first wireless communication network, the second base station being is present in the vicinity of the relay device;
determining whether a connection is capable of being established between the second base station and the terminal; and
stopping relay of the communication so that a connection target of the terminal is switched from the relay device to the second base station if the connection between the second base station and the terminal is capable of being established.

12. The communication control method according to claim 11, further comprising:
monitoring a communication quality between the second base station and the terminal after stopping the relay of the communication; and
restarting the relay of the communication if the communication quality does not satisfy a certain communication quality.

13. The communication control method according to claim 11, further comprising:
obtaining, from another device, setting information for setting the connection between the second base station and the terminal.

14. The communication control method according to claim 13, further comprising:
confirming whether the terminal has the setting information when the connection between the second base station and the terminal is capable of being established; and
notifying the terminal of the setting information if the terminal does not have the setting information.

15. The communication control method according to claim 14, wherein
the relay of the communication is stopped after notifying the setting information.

16. The communication control method according to claim 11, further comprising:
measuring position information of the relay device; and
obtaining first identification information of a third base station in the second wireless communication network that is present within a certain range based on the position indicated by the position information.

17. The communication control method according to claim 16, further comprising:
identifying the third base station in the second wireless communication network as the second base station if the first identification information matches second identification information included in a signal transmitted from the third base station in the second wireless communication network.

18. The communication control method according to claim 11, further comprising:
relaying communication between the first base station in the first wireless communication network and a plurality of terminals including the terminal;
determining whether a connection is capable of being established between the second base station and each of the plurality of terminals; and
stopping the relay of the communication if the connection is capable of being established between the second base station and all of the plurality of the terminals.

19. The communication control method according to claim 18, further comprising:
monitoring a communication quality between the second base station and each of the plurality of terminals after stopping the relay of the communication; and
restarting the relay of the communication if the communication quality between the second base station and at least one terminal among the plurality of terminals does not satisfy a certain communication quality.

20. The communication control method according to claim 11, further comprising:
monitoring a communication quality between the relay device and the first base station; and
continuing the relay of the communication if the communication quality satisfies a certain communication quality even if the connection is capable of being established.
